(19) United States
(12) Patent Application Publication
(10) Pub. No.: US 2024/0399853 A1
(43) Pub. Date: Dec. 5, 2024

(54) ELECTRIC VEHICLE DIELECTRIC FLUID COOLING CIRCUIT WITH THERMAL EXPANSION CHAMBER

(71) Applicant: FCA US LLC, Auburn Hills, MI (US)

(72) Inventor: Christopher Capitan, Sterling Heights, MI (US)

(21) Appl. No.: 18/326,436

(22) Filed: May 31, 2023

(51) Int. Cl. B60K 11/02; B60K 1/00; B60L 58/26

(52) U.S. Cl. CPC B60K 11/02; B60K 1/00; B60L 58/26; B60K 2001/005; B60K 2001/006

(57) ABSTRACT

A cooling system for an electrified vehicle powertrain includes a cooling circuit fluidly coupling at least a traction battery and an electric motor, a pump, a heat exchange device and an expansion and contraction chamber. The circuit is a closed circuit sealed from the atmosphere and substantially free of atmospheric air, with the pump circulating dielectric fluid through the circuit for cooling at least the traction battery and electric motor, with the dielectric fluid being in direct contact with the battery cells. The expansion chamber provides a volume in the circuit for thermal expansion of the dielectric fluid as the temperature of the dielectric fluid increases, and is pressurized above atmospheric pressure with an inert gas or a gas that is non-reactive to the dielectric fluid, the gas being lighter than the dielectric fluid and compressing within the expansion chamber with the thermal expansion of the dielectric fluid.

### FIELD

The present application generally relates to a cooling circuit for electrified drive systems of electric vehicles and, more particularly, to an electric vehicle dielectric fluid cooling circuit having a thermal expansion chamber.

### BACKGROUND

Electric vehicle traction batteries can be cooled using air cooling or liquid cooling. Liquid cooling is emerging as the preferred active cooling method to cool today's traction batteries. Conventional liquid cooling utilizes an ethylene glycol/water mixture to cool the traction batteries, similar to or the same as for a cooling system of an internal combustion engine. This ethylene glycol/water mixture cannot come into direct contact with the battery cells and is therefore circulated through passages, tubes or cold plates that surround the battery cells of the traction battery to carry heat away from the battery cells to cool the cells. This is an indirect cooling method because the components that carry the ethylene glycol/water mixture prevent direct electrical contact between the cells and this liquid coolant. While this cooling method is effective and used in today's electric vehicles, there are cooling inefficiencies due to loss of heat transfer because the cooling method is indirect. Thus, there remains a desire for improved cooling performance of traction batteries for electric vehicles.

### SUMMARY

According to one example aspect of the invention, an electric vehicle cooling system using a dielectric cooling fluid is provided. In one exemplary implementation, the electric vehicle cooling system includes: a cooling circuit fluidly coupling a traction battery, an electric motor and optionally an inverter, a fluid pump, a heat exchange device and an expansion and contraction chamber. The cooling circuit is a closed circuit sealed from the atmosphere and substantially free of atmospheric air; with the pump circulating the dielectric fluid through the cooling circuit for cooling the traction battery, electric motor and optionally the inverter, and the dielectric fluid being circulated in direct contact with battery cells of the traction battery. The expansion and contraction chamber is configured to provide a sealed pressure volume in the cooling circuit to allow for thermal expansion and contraction of the dielectric fluid as the temperature of the dielectric fluid increases with increasing temperature of one or more of the traction battery, electric motor and inverter; and the expansion chamber is pressurized above atmospheric pressure with an inert gas or a gas that is non-reactive to the dielectric fluid, where the gas is lighter than the dielectric fluid and compresses within the expansion chamber with the thermal expansion of the dielectric fluid.

In some implementations, the expansion chamber includes an outer housing forming an internal volume sealed from the atmosphere, where the internal volume includes only two portions, a first portion filled by the dielectric fluid and a second remaining portion filled by the inert or non-reactive gas. In some implementations, the inert or non-reactive gas is pressurized in the expansion chamber and forms a layer or covering over the dielectric fluid. In some implementations, the inert or non-reactive gas is under a pressure in the interior volume greater than atmospheric pressure and performs a spring function reacting against the thermal expansion of the dielectric fluid as the temperature of the dielectric fluid increases.

In some implementations, the expansion chamber is a standalone chamber separate and distinct from the battery pack. In some implementations, the expansion chamber is positioned inside an exterior housing that houses both the battery pack and the outer housing of the expansion chamber. In such implementations, the battery pack includes an outer housing, and wherein the battery pack outer housing is separate and distinct from the expansion chamber outer housing. In such implementations, the dielectric fluid fills an interior volume of the battery pack outer housing thereby submerging the battery cells and fills the first portion of the interior volume of the expansion chamber.

In some implementations, the expansion chamber comprises a portion of an interior volume formed by an outer housing of the battery pack, wherein the interior volume of the battery pack outer housing surrounds both the expansion chamber and the battery cells without a physical separation therebetween. In such implementations, the internal volume of the battery pack outer housing comprises only two portions, a first portion filled by the dielectric fluid and submerging the battery cells therein, and a second remaining portion filled by the inert or non-reactive gas.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a high level schematic illustration of an electric vehicle cooling circuit according to the principles of the present application;

FIG. 2 is a high level schematic illustration of the expansion chamber shown in the cooling circuit of FIG. 1 according to the principles of the present application;

FIG. 3 is a high level schematic illustration of an electric vehicle cooling circuit according to the principles of the present application;

FIG. 4 is a high level schematic illustration of the battery pack assembly shown in the cooling circuit of FIG. 1 or 4 according to the principles of the present application; and

FIG. 5 is a high level schematic illustration of the battery pack assembly shown in the cooling circuit of FIG. 1 or 4 according to the principles of the present application.

### DETAILED DESCRIPTION

As previously discussed, electric vehicle cooling circuits conventionally use an ethylene glycol/water mixture for cooling and this requires an indirect cooling method for the battery cells because this liquid coolant cannot come into direct electrical contact with the cells. This indirect cooling method is utilized on today's electric vehicles and does work for its intended purpose, but also results in heat exchange losses due to the indirect heat exchange contact between the cells and the liquid coolant. Improved cooling of the battery would allow the battery to operate more efficiently and often provide more power because the temperature of the battery would be better regulated with such improved cooling.

Accordingly, an improved cooling circuit for an electric vehicle is provided and discussed herein. In one example implementation, the improved cooling circuit utilizes a dielectric fluid designed and configured to come into direct contact with battery cells of the traction battery. This provides a direct cooling method with improved thermal heat exchange between the battery cells and the dielectric fluid due to the fluid coming into direct contact with the heat source.

One drawback of dielectric fluid besides its notable cost increase as compared to the ethylene glycol/water mixture, is its greater thermal expansion. Another drawback of the dielectric fluid is its incompatibility with atmospheric air. Dielectric fluids, such as dielectric cooling oils, age rapidly when exposed to atmospheric air and/or water vapor, which will thus render these expensive cooling fluids essentially unusable. Conventional thermal expansion bottles for ethylene glycol/water mixture cooling systems are not environmentally sealed from the atmosphere, sometimes even when capped, and others breathe to the atmosphere.

Accordingly, the improved cooling circuit using dielectric fluid presented herein further includes an expansion chamber environmentally sealed from the atmosphere and designed to compensate for the greater thermal expansion of the dielectric fluid. Further, in addition to the chamber being environmentally sealed, the chamber is also filled with a pressurized inert or non-reactive gas, which essentially forms a blanket over the dielectric fluid in the expansion chamber. This inert or non-reactive gas blanket not only provides pressure balance to the cooling circuit in the form of a gas spring, but also adds an additional layer of protection against the dielectric fluid being exposed to the atmosphere, such as through fill valves and pressure relief valves forming an interface between the tank interior and the atmosphere.

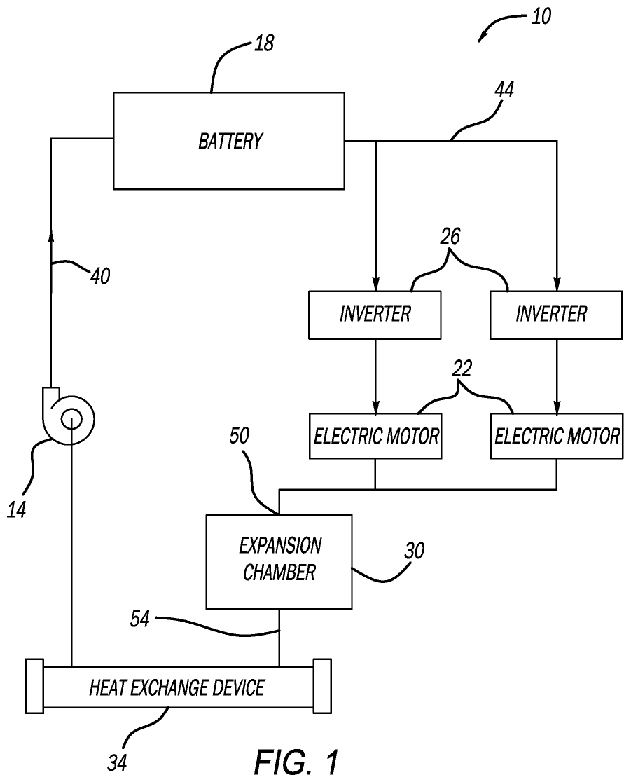

Turning now to the drawings, FIG. 1 shows at reference numeral 10 a high level schematic illustration of an improved dielectric cooling circuit for an electric vehicle. In the example implementation illustrated, the cooling circuit 10 includes a fluid pump 14, a traction battery pack 18, one or more electric motors 22 and associated inverters 26, an expansion chamber, volume or tank 30 and a heat exchange device 34, such as a radiator. The cooling circuit 10 is a closed or substantially closed circuit and sealed from the atmosphere, where the fluid pump 14 circulates dielectric fluid 40 through conduits or passages or tubing or pathways 44 connecting the above-identified components and forming part of the cooling circuit 10. It will be appreciated that the cooling circuit 10 is shown in simplistic schematic form eliminating other components known to the skilled artisan for clarity of discussion. It will also be appreciated that the order and placement of the components of cooling circuit 10 are schematically shown for illustration and discussion purposes only and may not represent the actual order and placement of such components in an electric vehicle.

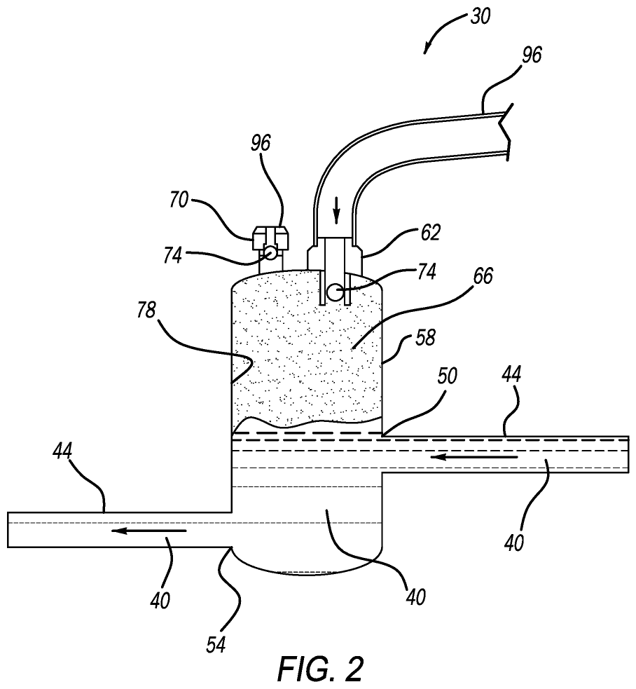

With additional reference to FIG. 2 and continuing reference to FIG. 1, the expansion chamber 30 will now be discussed in greater detail. In one example implementation, the expansion chamber 30 is in the form of a tank having an inlet 50 and an outlet 54 for the flow of dielectric fluid 40 therethrough, as may be needed depending on the cooling needs of the battery pack 18 and the thermal expansion of the dielectric fluid 40 during operation of the electric vehicle and associated load placed on the battery pack 18. The expansion chamber 30 also includes an outer housing 58, an inlet 62 for supply of pressurized gas 66 and an outlet 70 for pressure relief or venting of the gas 66 in chamber 30.

The inlet 62 and outlet 70 both include valves 74, such as controllable or passive check valves, for selectively sealing an inner volume 78 of chamber 30 from the atmosphere. With controllable valves, such valves can be in signal communication with a controller or control module of the electric vehicle having cooling circuit 10. It will be appreciated that the shape of the expansion chamber 30 can take various forms depending on its actual placement in the cooling circuit and/or constraints of the surrounding vehicle environment and/or components.

In the example expansion chamber 30 illustrated in FIG. 2, the interior volume 78 is partially filled with the non-reactive gas 66, such as Nitrogen. This non-reactive gas 66 is lighter than the dielectrics fluid and thus essentially rests on top of the dielectric fluid in interior volume 78, as shown in FIG. 2. The gas 66 also does not react with the dielectric fluid and thus does not degrade the dielectric fluid properties. As briefly mentioned above, the gas 66 not only provides flexible pressurization to the expansion chamber 30 in the form of a gas spring, but also provides an added layer of protection between the atmosphere and the dielectric fluid 40. In the example implementations discussed herein, the cooling circuit and its interior volume, including the interior volume of the expansion chamber, is free or substantially free of any atmospheric air.

In terms of the flexible pressurization, the gas 66 provides a spring-like function to the expansion chamber because the inert gas 66 is compressible. In terms of providing protection from exposure to atmospheric air, the gas 66 will fill a sub-volume of the interior 78 of chamber 30 not filled by dielectric fluid 40 in place of atmospheric air. In one example implementation, the interior volume 78 of chamber 38 is purged of air, such as by vacuum or pressurizing the volume with the non-reactive gas 66 and venting to atmosphere such that there is not any or substantially not any atmospheric air in interior volume 78 thereafter. Moreover, as shown in FIG. 2, the gas 66 resides above dielectric fluid 40 and essentially provides a blanket over the same, preventing or substantially preventing the dielectric fluid 40 coming into contact with the inlets and outlet 62, 70 and any small amount of atmospheric air that may potentially leak or seep into interior volume therethrough.

The inlet 50 and outlet 54 for the dielectric fluid can be positioned relative to a bottom 84 of chamber 30 such that the inlet and outlet 50, 54 will always be submerged in dielectric fluid 40 during operating conditions and environmental conditions of the electric vehicle. For example, the cooling circuit 10 can be developed taking into account lowering of the dielectric fluid level 40 in volume 78 due to any draw on dielectric fluid 40 from expansion chamber 30 during operation of the electric vehicle, as well as any such draw during coldest operating conditions of the dielectric fluid, which would represent it lowest volume and lowest fluid level in the expansion chamber 30.

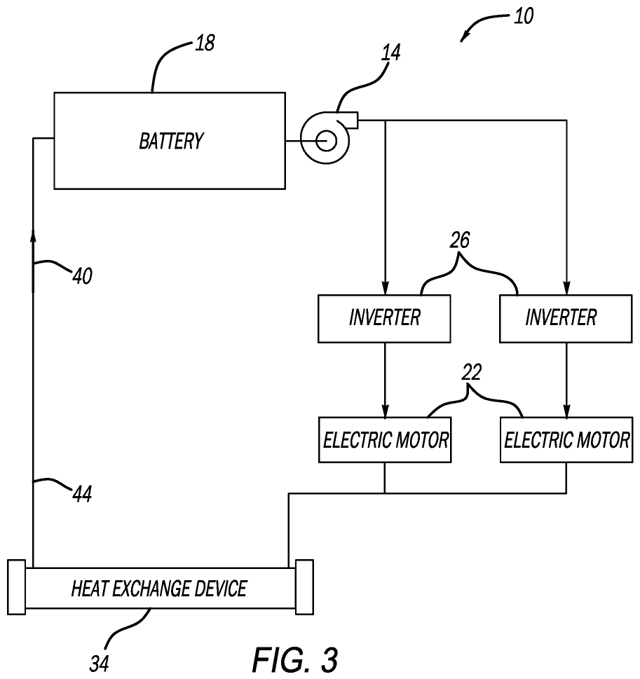

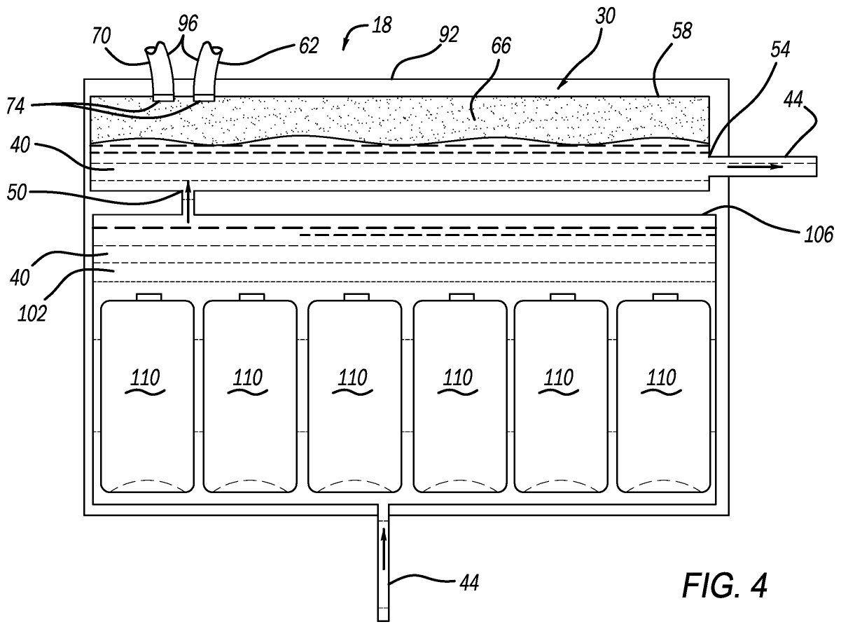

Turning now to FIGS. 3-4 and with continuing reference to FIGS. 1-2, example placement of the expansion chamber 30 within the battery pack 18 will now be discussed. In this example implementation, the expansion chamber 30 of FIG. 2 is alternatively placed within an outer housing 92 formed around battery pack 18. In one example of this implementation, the expansion chamber 30 of FIG. 4 is the same as the expansion chamber 30 of FIG. 2, with the connections 96 associated with the inlet and outlet 62, 70 extending through housing 92 for accessibility.

As with the cooling circuit 10 shown in FIG. 1, where the battery pack 18 would be the same as in FIG. 4 but for removal of expansion chamber 30, an interior volume 102 of battery pack outer housing 106 within outer housing 92 is filled with dielectric fluid 40 such that the individual battery cells or modules 110 are submerged in the dielectric fluid 40 for direct contact thermal heat exchange cooling. In this example implementation shown in FIG. 2, the outer housing 92 houses two separate internal volumes, volume 102 formed by housing 106 for the battery pack 18 itself, and volume 78 formed by expansion chamber 30. In this example implementation, the dielectric fluid 40 fills all or substantially all of the inner volume 102 of battery pack housing 106 and flows from the housing 106 into the expansion chamber 30 inner volume 78 and then out to circuit pathway 44.

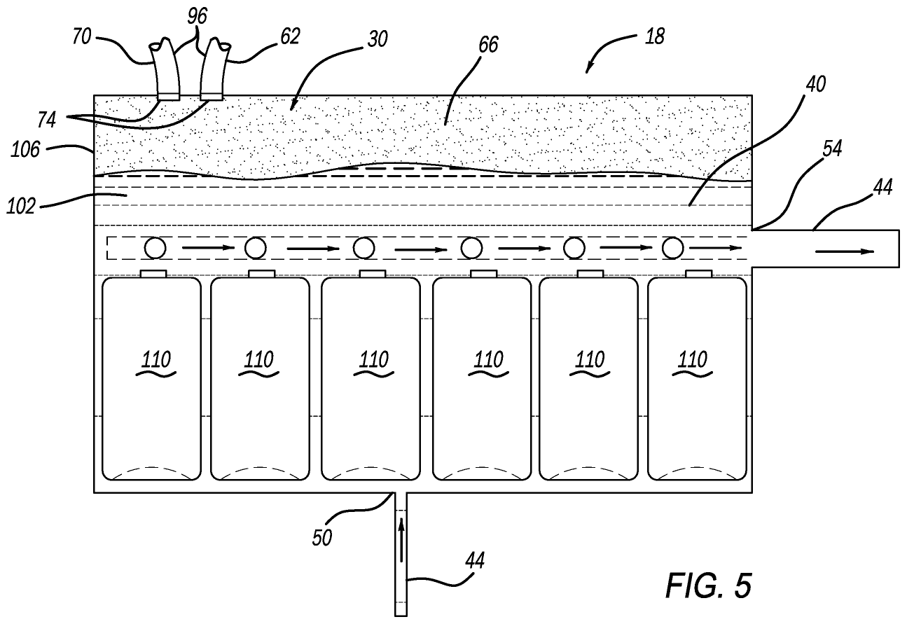

Turning now to FIG. 5 and with continuing reference to FIGS. 1-4, another example placement of an expansion chamber or volume 30 within the battery pack 18 will now be discussed. In this example implementation, the expansion chamber or volume 30 is included within the battery pack housing 106 and is not separate or distinct therefrom as in FIG. 4. In this implementation, the interior volume 102 of housing 106 integrally forms the expansion volume or chamber 30 without separation from the battery cells 110. In this implementation, the dielectric fluid 40 partially fills inner volume 102 of housing 106 and submerges the battery cells or modules 110. An upper remaining portion of volume 102 above battery cells/modules 110 and an upper level of dielectric fluid 40 is filled with the pressurized gas 66. Other than not having a distinct housing 58, expansion volume 30 and the gas 66 therein has the same or substantially the same characteristics, functions and features as for expansion chamber 30 discussed in connection with FIGS. 1-4.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric vehicle cooling system using a dielectric cooling fluid, the cooling circuit comprising:
a cooling circuit fluidly coupling at least a traction battery, an electric motor, a fluid pump, a heat exchange device and an expansion and contraction chamber;
wherein the cooling circuit is a closed circuit sealed from the atmosphere and substantially free of atmospheric air;
wherein the pump circulates the dielectric fluid through the cooling circuit for cooling at least the traction battery and electric motor, the dielectric fluid being circulated in direct contact with battery cells of the traction battery;
wherein the expansion and contraction chamber is configured to provide a sealed volume in the cooling circuit to allow for thermal expansion of the dielectric fluid as the temperature of the dielectric fluid increases with increasing temperature of one or more of at least the traction battery and electric motor; and
wherein the expansion and contraction chamber is pressurized above atmospheric pressure with an inert gas or a gas that is non-reactive to the dielectric fluid, the gas being lighter than the dielectric fluid and configured to compresses within the expansion chamber with the thermal expansion of the dielectric fluid.

2. The electric vehicle cooling system of claim 1, wherein the expansion and contraction chamber includes an outer housing forming an internal volume sealed from the atmosphere, and wherein the internal volume comprises only two portions, a first portion filled by the dielectric fluid and a second, remaining portion filled by the inert or non-reactive gas.

3. The electric vehicle cooling system of claim 2, wherein the inert or non-reactive gas is pressurized in the expansion chamber and forms a layer or covering over the dielectric fluid.

4. The electric vehicle cooling system of claim 2, wherein the inert or non-reactive gas is under a pressure in the interior volume greater than atmospheric pressure and performs a spring function reacting against the thermal expansion of the dielectric fluid as the temperature of the dielectric fluid increases.

5. The electric vehicle cooling system of claim 2, wherein the expansion and contraction chamber is a standalone chamber separate and distinct from the battery pack.

6. The electric vehicle cooling system of claim 2, wherein the expansion and contraction chamber is positioned inside an exterior housing that houses both the battery pack and the outer housing of the expansion and contraction chamber.

7. The electric vehicle cooling system of claim 6, wherein the battery pack includes an outer housing, and wherein the battery pack outer housing is separate and distinct from the expansion and contraction chamber outer housing.

8. The electric vehicle cooling system of claim 7, wherein the dielectric fluid fills an interior volume of the battery pack outer housing thereby submerging the battery cells and fills the first portion of the interior volume of the expansion and contraction chamber.

9. The electric vehicle cooling system of claim 1, wherein the expansion and contraction chamber comprises a portion of an interior volume formed by an outer housing of the battery pack, wherein the interior volume of the battery pack outer housing surrounds both the expansion and contraction chamber and the battery cells without a physical separation therebetween.

10. The electric vehicle cooling system of claim 9, wherein the internal volume of the battery pack outer housing comprises only two portions, a first portion filled by the dielectric fluid and submerging the battery cells therein, and a second remaining portion filled by the inert or non-reactive gas.
